(19) United States
(12) Patent Application Publication
(10) Pub. No.: US 2009/0010333 A1
(43) Pub. Date: Jan. 8, 2009

(54) Method and Apparatus for Constrained Prediction for Reduced Resolution Update Mode and Complexity Scalability in Video Encoders and Decoders

(76) Inventors: Alexandros Tourapis, Burbank, CA (US); Jill MacDonald Boyce, Manalapan, NJ (US); Peng Yin, West Windsor, NJ (US)

Correspondence Address: Joseph J. Laks;Thomson Licensing LLC, 2 Independence Way, Patent Operations, PO Box 5312, PRINCETON, NJ, 08543, US

(21) Appl. No.: 12/087,370

(22) PCT Filed: Jan. 30, 2007
(86) PCT No.: PCT/US2007/002383

§ 371 Date: Jul. 2, 2008

Related U.S. Application Data
(60) Provisional application No. 60/764,253, filed on Jan. 31, 2006.

(51) Int. Cl. H04N 7/26

(52) U.S. Cl. 375/240.15; 375/E07.147

(57) ABSTRACT

There are provided methods and apparatus for constrained prediction for reduced resolution update mode and complexity scalability in video encoders and decoders. A scalable complexity video encoder includes an encoder for encoding a block in a particular picture in the video sequence by generating an intra mode prediction for the block using a constrained intra prediction process that reduces artifacts for both low and high resolutions in a reduced resolution update mode when the particular picture is eventually decoded. The constrained intra prediction process reduces the artifacts by prohibiting the use of particular prediction modes associated with the introduction of the artifacts in the reduced resolution update mode.

### CROSS-REFERENCE TO RELATED APPLICATIONS

This application claims the benefit of U.S. Provisional Application Ser. No. 60/764,253, filed 31 Jan. 2006, which is incorporated by reference herein in its entirety.

### TECHNICAL FIELD

The present principles relate generally to video encoding and decoding and, more particularly, to a method and apparatus for constrained prediction for Reduced Resolution Update mode and complexity scalability in video encoders and decoders.

### BACKGROUND

It is desirable for a broadcast video application to provide support for diverse user devices, without incurring the bitrate penalty of simulcast encoding. Video decoding is a complex operation, and the complexity is very dependent on the resolution of the coded video. Low power portable devices typically have very strict complexity restrictions and low resolution displays. Simulcast broadcast of two or more video bitstreams corresponding to different resolutions can be used to address the complexity requirements of the lower resolution devices, but requires a higher total bitrate than a complexity scalable system in accordance with the present invention. Accordingly, there is a need for a solution that allows for complexity scalable decoders while maintaining high video coding bitrate efficiency.

Many different methods of scalability have been widely studied and standardized, including SNR scalability, spatial scalability, temporal scalability, and fine grain scalability, in scalability profiles of the MPEG-2 and MPEG-4 standards. Most of the work in scalable coding has been aimed at bitrate scalability, where the low resolution layer has a limited bandwidth. As shown in FIG. 1, a typical spatial scalability system is indicated generally by the reference numeral 100. The system 100 includes a complexity scalable video encoder 110 for receiving a video sequence. A first output of the complexity scalable video encoder 110 is connected in signal communication with a low bandwidth network 120 and with a first input of a multiplexer 130. A second output of the complexity scalable video encoder 110 is connected in signal communication with a second input of the multiplexer 130. An output of the low bandwidth network 120 is connected in signal communication with an input of a low resolution decoder 140. An output of the multiplexer 130 is connected in signal communication with an input of a high bandwidth network 150. An output of the high bandwidth network 150 is connected in signal communication with an input of a demultiplexer 160. A first output of the demultiplexer 160 is connected in signal communication with a first input of a high resolution decoder 170, and a second output of the demultiplexer 160 is connected in signal communication with a second input of the high resolution decoder 170. An output of the low-resolution decoder 140 is available as an output of the system 100 for a base layer bitstream, and an output of the high-resolution decoder 170 is available as an output of the system 100 for a scalable bitstream.

Scalable coding has not been widely adopted in practice, because of the considerable increase in encoder and decoder complexity, and because the coding efficiency of scalable encoders is typically well below that of non-scalable encoders.

Spatially scalable encoders and decoders typically require that the high resolution scalable encoder/decoder provide additional functionality than would be present in a normal high resolution encoder/decoder. In an MPEG-2 spatial scalable encoder, a decision is made whether prediction is performed from a low resolution reference picture or from a high resolution reference picture. An MPEG-2 spatial scalable decoder must be capable of predicting either from the low resolution reference picture or the high resolution reference picture. Two sets of reference picture stores are required by an MPEG-2 spatial scalable encoder/decoder, one for low resolution pictures and another for high resolution pictures. FIG. 2 shows a block diagram for a low-complexity spatial scalable encoder 200 supporting two layers, according to the prior art. FIG. 3 shows a block diagram for a low-complexity spatial scalable decoder 300 supporting two layers, according to the prior art.

Turning to FIG. 2, a spatial scalable video encoder supporting two layers is indicated generally by the reference numeral 200. The video encoder 200 includes a downsampler 210 for receiving a high-resolution input video sequence. The downsampler 210 is coupled in signal communication with a low-resolution non-scalable encoder 212, which, in turn, is coupled in signal communication with low-resolution frame stores 214. The low-resolution non-scalable encoder 212 outputs a low-resolution bitstream, and is further coupled in signal communication with a low-resolution non-scalable decoder 220.

The low-resolution non-scalable decoder 220 is coupled in signal communication with an upsampler 230, which, in turn, is coupled in signal communication with a scalable high-resolution encoder 240. The scalable high-resolution encoder 240 also receives the high-resolution input video sequence, is coupled in signal communication with high-resolution frame stores 250, and outputs a high-resolution scalable bitstream. An output of the low-resolution non-scalable encoder 212 and an output of the scalable high-resolution encoder 240 are available as outputs of the spatial scalable video encoder 200.

Thus, a high resolution input video sequence is received by the low-complexity encoder 200 and down-sampled to create a low-resolution video sequence. The low-resolution video sequence is encoded using a non-scalable low-resolution video compression encoder, creating a low-resolution bitstream. The low-resolution bitstream is decoded using a non-scalable low-resolution video compression decoder. This function may be performed inside of the encoder. The decoded low-resolution sequence is up-sampled, and provided as one of two inputs to a scalable high-resolution encoder. The scalable high-resolution encoder encodes the video to create a high-resolution scalable bitstream.

Turning to FIG. 3, a spatial scalable video decoder supporting two layers is indicated generally by the reference numeral 300. The video decoder 300 includes a low-resolution decoder 360 for receiving a low-resolution bitstream, which is coupled in signal communication with low-resolution frame stores 362, and outputs a low-resolution video sequence. The low-resolution decoder 360 is further coupled in signal communication with an upsampler 370, which, in turn, is coupled in signal communication with a scalable high-resolution decoder 380.

The scalable high-resolution decoder 380 is further coupled in signal communication with high-resolution frame stores 390. The scalable high-resolution decoder 380 receives a high-resolution scalable bitstream and outputs a high-resolution video sequence. An output of the low-resolution decoder 360 and an output of the scalable high-resolution decoder are available as outputs of the spatial scalable video decoder 300.

Thus, both a high-resolution scalable bitstream and low-resolution bitstream are received by the low-complexity decoder 300. The low-resolution bitstream is decoded using a non-scalable low-resolution video compression decoder, which utilizes low-resolution frame stores. The decoded low-resolution video is up-sampled, and then input into a high-resolution scalable decoder. The high-resolution scalable decoder utilizes a set of high-resolution frame stores, and creates the high-resolution output video sequence.

Turning to FIG. 4, a non-scalable video encoder is indicated generally by the reference numeral 400. An input to the video encoder 400 is connected in signal communication with a non-inverting input of a combiner 410. The output of the combiner 410 is connected in signal communication with a transformer/quantizer 420. The output of the transformer/quantizer 420 is connected in signal communication with an entropy coder 440. An output of the entropy coder 440 is available as an output of the encoder 400.

The output of the transformer/quantizer 420 is further connected in signal communication with an inverse transformer/quantizer 450. An output of the inverse transformer/quantizer 450 is connected in signal communication with an input of a deblock filter 460. An output of the deblock filter 460 is connected in signal communication with reference picture stores 470. A first output of the reference picture stores 470 is connected in signal communication with a first input of a motion estimator 480. The input to the encoder 400 is further connected in signal communication with a second input of the motion estimator 480. The output of the motion estimator 480 is connected in signal communication with a first input of a motion compensator 490. A second output of the reference picture stores 470 is connected in signal communication with a second input of the motion compensator 490. The output of the motion compensator 490 is connected in signal communication with an inverting input of the combiner 410.

Turning to FIG. 5, a non-scalable video decoder is indicated generally by the reference numeral 500. The video decoder 500 includes an entropy decoder 510 for receiving a video sequence. A first output of the entropy decoder 510 is connected in signal communication with an input of an inverse quantizer/transformer 520. An output of the inverse quantizer/transformer 520 is connected in signal communication with a first non-inverting input of a combiner 540.

The output of the combiner 540 is connected in signal communication with an input of a deblock filter 590. An output of the deblock filter 590 is connected in signal communication with an input of a reference picture stores 550. An output of the reference picture stores 550 is connected in signal communication with a first input of a motion compensator 560. An output of the motion compensator 560 is connected in signal communication with a second non-inverting input of the combiner 540. A second output of the entropy decoder 510 is connected in signal communication with a second input of the motion compensator 560. The output of the deblock filter 590 is available as an output of the video decoder 500.

It has been proposed that H.264/MPEG AVC be extended to use a Reduced Resolution Update (RRU) mode. The RRU mode improves coding efficiency at low bitrates by reducing the number of residual macroblocks (MBs) to be coded, while performing motion estimation and compensation of full resolution pictures. Turning to FIG. 6, a Reduced Resolution Update (RRU) video encoder is indicated generally by the reference numeral 600. An input to the video encoder 600 is connected in signal communication with a non-inverting input of a combiner 610. The output of the combiner 610 is connected in signal communication with an input of a downsampler 612. An input of a transformer/quantizer 620 is connected in signal communication with an output of the downsampler 612 or with the output of the combiner 610. An output of the transformer/quantizer 620 is connected in signal communication with an entropy coder 640. An output of the entropy coder 640 is available as an output of the video encoder 600.

The output of the transformer/quantizer 620 is further connected in signal communication with an input of an inverse transformer/quantizer 650. An output of the inverse transformer/quantizer 650 is connected in signal communication with an input of an upsampler 655. An input of a deblock filter 660 is connected in signal communication with an output of the inverse transformer/quantizer 650 or with an output of the upsampler 655. An output of the deblock filter 660 is connected in signal communication with an input of reference picture stores 670. A first output of the reference picture stores 670 is connected in signal communication with a first input of a motion estimator 680. The input to the encoder 600 is further connected in signal communication with a second input of the motion estimator 680. The output of the motion estimator 680 is connected in signal communication with a first input of a motion compensator 690. A second output of the reference picture stores 670 is connected in signal communication with a second input of the motion compensator 690. The output of the motion compensator 690 is connected in signal communication with an inverting input of the combiner 610.

Turning to FIG. 7, a Reduced Resolution Update (RRU) video decoder is indicated generally by the reference numeral 700. The video decoder 700 includes an entropy decoder 710 for receiving a video sequence. An output of the entropy decoder 710 is connected in signal communication with an input of an inverse quantizer/transformer 720. An output of the inverse quantizer/transformer 720 is connected in signal communication with an input of an upsampler 722. An output of the upsampler 722 is connected in signal communication with a first input of a combiner 740.

An output of the combiner 740 is connected in signal communication with a deblock filter 790. An output of the deblock filter 790 is connected in signal communication with an input of full resolution reference picture stores 750. The output of the deblock filter 790 is also available as an output of the video decoder 700. An output of the full resolution reference picture stores 750 is connected in signal communication with a motion compensator 760, which is connected in signal communication with a second input of the combiner 740.

It has been proposed to use a RRU concept to design a complexity scalable codec. An example is provided for a system that supports two different levels of decoder complexity and resolution. A low resolution decoder has a smaller display size and has very strict decoder complexity constraints. A full resolution decoder has a larger display size and less strict but still important decoder complexity constraints. A broadcast or multicast system transmits two bitstreams, a base layer with bitrate BR_{base} and an enhancement layer with bitrate BRₑₙₕₐₙ. The two bitstreams may be multiplexed together and sent in a single transport stream. Turning to FIG. 8, a complexity scalability broadcast system is indicated generally by the reference numeral 800. The complexity scalability broadcast system 800 includes a complexity scalable video encoder 810 and a low resolution decoder 850 and a full resolution decoder 870. A first output of the complexity scalable video encoder 810 is connected in signal communication with a first input of a multiplexer 820. A second output of the complexity scalable video encoder 810 is connected in signal communication with a second input of the multiplexer 820. An output of the multiplexer 820 is connected in signal communication with a network 830. An output of the network 830 is connected in signal communication with an input of a first demultiplexer 840 and with an input of a second demultiplexer 850. An output of the first demultiplexer 840 is connected in signal communication with an input of a low resolution decoder 850. A first output of the second demultiplexer 860 is connected in signal communication with a first input of a full resolution decoder 870. A second output of the second demultiplexer 860 is connected in signal communication with a second input of the full resolution decoder 870. An output of the low-resolution decoder 850 is available as an output of the system 800 for a base layer bitstream, and an output of the full-resolution decoder 870 is available as an output of the system 800 for a scalable bitstream.

The low-resolution decoder 850 processes only the base layer bitstream and the full resolution decoder 870 processes both the base layer bitstream and the enhancement layer bitstream. RRU is used in the base layer, which can be decoded into both low resolution and high resolution sequences with different complexity at the decoder. The enhancement layer bitstream includes a full resolution error signal, to be added to the result of decoding the base layer bitstream, which was done with full resolution motion compensation. The bitrate of the enhancement layer may end up being lower than that of the base layer, which differs from the typical spatial scalability case where the base layer bitrate is typically small compared with the enhancement layer bitrate. A full resolution error signal is not necessarily sent for every coded macroblock or slice/picture.

### SUMMARY

These and other drawbacks and disadvantages of the prior art are addressed by the present principles, which are directed to a method and apparatus for constrained prediction for Reduced Resolution Update mode and complexity scalability in video encoders and decoders.

According to an aspect of the present principles, there is provided a scalable complexity video encoder for encoding a video sequence. The scalable complexity video encoder includes an encoder for encoding a block in a particular picture in the video sequence by generating an intra mode prediction for the block using a constrained intra prediction process that reduces artifacts for both low and high resolutions in a Reduced Resolution Update mode when the particular picture is eventually decoded. The constrained intra prediction process reduces the artifacts by prohibiting the use of particular prediction modes associated with the introduction of the artifacts in the Reduced Resolution Update mode.

According to another aspect of the present principles, there is provided a method for scalable complexity video encoding of a video sequence. The method includes encoding a block in a particular picture in the video sequence by generating an intra mode prediction for the block using a constrained intra prediction process that reduces artifacts for both low and high resolutions in a Reduced Resolution Update mode when the particular picture is eventually decoded. The constrained intra prediction process reduces the artifacts by prohibiting the use of particular prediction modes associated with the introduction of the artifacts in the Reduced Resolution Update mode.

According to yet another aspect of the present principles, there is provided a scalable complexity video decoder for decoding a video bitstream. The scalable complexity video decoder includes a decoder for decoding a block in a particular picture in the video bitstream using an intra mode prediction for the block generated based upon a constrained intra prediction process that reduces artifacts for both low and high resolutions in a Reduced Resolution Update mode when the particular picture is eventually decoded. The constrained intra prediction process reduces the artifacts by prohibiting the use of particular prediction modes associated with the introduction of the artifacts in the Reduced Resolution Update mode.

According to a further aspect of the present principles, there is provided a method for scalable complexity video decoding of a video bitstream. The method includes decoding a block in a particular picture in the video bitstream using an intra mode prediction for the block generated based upon a constrained intra prediction process that reduces artifacts for both low and high resolutions in a Reduced Resolution Update mode when the particular picture is eventually decoded. The constrained intra prediction process reduces the artifacts by prohibiting the use of particular prediction modes associated with the introduction of the artifacts in the Reduced Resolution Update mode.

According to a yet further aspect of the present principles, there is provided a scalable complexity video encoder for encoding a video sequence. The scalable complexity video encoder includes an encoder for encoding a block in a particular high resolution picture in the video sequence at a high resolution by generating a low resolution intra mode prediction for the block in a Reduced Resolution Update mode.

According to a still further aspect of the present principles, there is provided a method for scalable complexity video encoding of a video sequence. The method includes encoding a block in a particular high resolution picture in the video sequence at a high resolution by generating a low resolution intra mode prediction for the block in a Reduced Resolution Update mode.

According to an additional aspect of the present principles, there is provided a scalable complexity video decoder for decoding a video bitstream. The scalable complexity video decoder includes a decoder for decoding a Reduced Resolution Update block in a particular picture in the video bitstream at a high resolution by performing a modified intra prediction process to reconstruct the Reduced Resolution Update block at a low resolution and upsampling the reconstructed Reduced Resolution Update block to the high resolution.

According to another aspect of the present principles, there is provided a method for scalable complexity video decoding of a video bitstream. The method includes decoding a Reduced Resolution Update block in a particular picture in the video bitstream at a high resolution by performing a modified intra prediction process to reconstruct the Reduced Resolution Update block at a low resolution and upsampling the reconstructed Reduced Resolution Update block to the high resolution.

According to yet another aspect of the present principles, there is provided a scalable complexity video encoder for encoding a video sequence. The scalable complexity video encoder includes an encoder for encoding a block in a particular picture in the video sequence by generating an intra mode prediction for the block using a modified intra prediction process that reduces artifacts in a Reduced Resolution Update mode when the particular picture is eventually decoded. The encoder renders encoding decisions for the modified intra prediction process based on respective qualities of a low resolution bitstream encoded from the video sequence and a downsampled source sequence encoded from the video sequence.

According to a further aspect of the present principles, there is provided a method for scalable complexity video encoding of a video sequence. The method includes encoding a block in a particular picture in the video sequence by generating an intra mode prediction for the block using a modified intra prediction process that reduces artifacts in a Reduced Resolution Update mode when the particular picture is eventually decoded. The encoding step renders encoding decisions for the modified intra prediction process based on respective qualities of a low resolution bitstream encoded from the video sequence and a downsampled source sequence encoded from the video sequence.

According to a yet further aspect of the present principles, there is provided a scalable complexity video encoder for encoding a video sequence. The scalable complexity video encoder includes an encoder for encoding a block in a particular picture in the video sequence by generating an intra mode prediction for the block using a modified intra prediction process that reduces artifacts in a Reduced Resolution Update mode when the particular picture is eventually decoded. The encoder renders encoding decisions for the modified intra prediction process based on respective qualities of both high and low resolution bitstreams encoded from the video sequence.

According to a still further aspect of the present principles, there is provided a method for scalable complexity video encoding of a video sequence. The method includes encoding a block in a particular picture in the video sequence by generating an intra mode prediction for the block using a modified intra prediction process that reduces artifacts in a Reduced Resolution Update mode when the particular picture is eventually decoded. The encoding step renders encoding decisions for the modified intra prediction process based on respective qualities of both high and low resolution bitstreams encoded from the video sequence.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 shows a block diagram for a typical spatial scalability system, according to the prior art;

FIG. 2 shows a block diagram for a spatial scalable encoder supporting two layers, according to the prior art;

FIG. 3 shows a block diagram for a spatial scalable decoder supporting two layers, according to the prior art;

FIG. 4 shows a block diagram for a normal non-scalable video encoder used in the H.264/MPEG AVC standard, according to the prior art;

FIG. 5 shows a block diagram for a normal non-scalable video decoder used with H.264/MPEG AVC, according to the prior art;

FIG. 6 shows a block diagram for a Reduced Resolution Update (RRU) video encoder, according to the prior art;

FIG. 7 shows a block diagram for a Reduced Resolution Update (RRU) video decoder, according to the prior art;

FIG. 8 shows a block diagram for a complexity scalability broadcast system, according to the prior art;

FIG. 9 shows a block diagram for a low resolution complexity scalable video decoder to which the present invention may be applied, in accordance with an embodiment of the present principles;

FIG. 10 shows a block diagram for a high resolution complexity scalable video decoder to which the present invention may be applied, in accordance with an embodiment of the present principles;

FIG. 11 shows a block diagram for a complexity scalable video encoder to which the present invention may be applied, in accordance with an embodiment of the present principles;

FIG. 12 shows a diagram for exemplary predictor pixels for a high complexity decoder, in accordance with an embodiment of the present principles;

FIG. 13 shows a diagram for exemplary predictor pixels for a low complexity decoder, in accordance with an embodiment of the present principles;

FIG. 14 shows a flow diagram for an exemplary method for encoding a macroblock using constrained intra prediction for a Reduced Resolution Update (RRU) mode, in accordance with an embodiment of the present principles;

FIG. 15 shows a flow diagram for an exemplary method for decoding a macroblock using constrained intra prediction for a Reduced Resolution Update (RRU) mode, in accordance with an embodiment of the present principles;

FIG. 16 shows a flow diagram for an exemplary method for encoding a macroblock of a high resolution picture in a video sequence at a high resolution using modified intra prediction for a Reduced Resolution Update (RRU) mode, in accordance with an embodiment of the present principles;

FIG. 17 shows a flow diagram for an exemplary method for decoding a macroblock of a high resolution picture in a video bitstream at a high resolution using modified intra prediction for a Reduced Resolution Update (RRU) mode, in accordance with an embodiment of the present principles;

FIG. 18 shows a flow diagram for an exemplary method for encoding a macroblock in a particular picture in a video sequence using a modified intra prediction process for a Reduced Resolution Update (RRU) mode, in accordance with an embodiment of the present principles; and

FIG. 19 shows a flow diagram for an exemplary method for encoding a macroblock in a particular picture in a video sequence using a modified intra prediction process for a Reduced Resolution Update (RRU) mode, in accordance with an embodiment of the present principles.

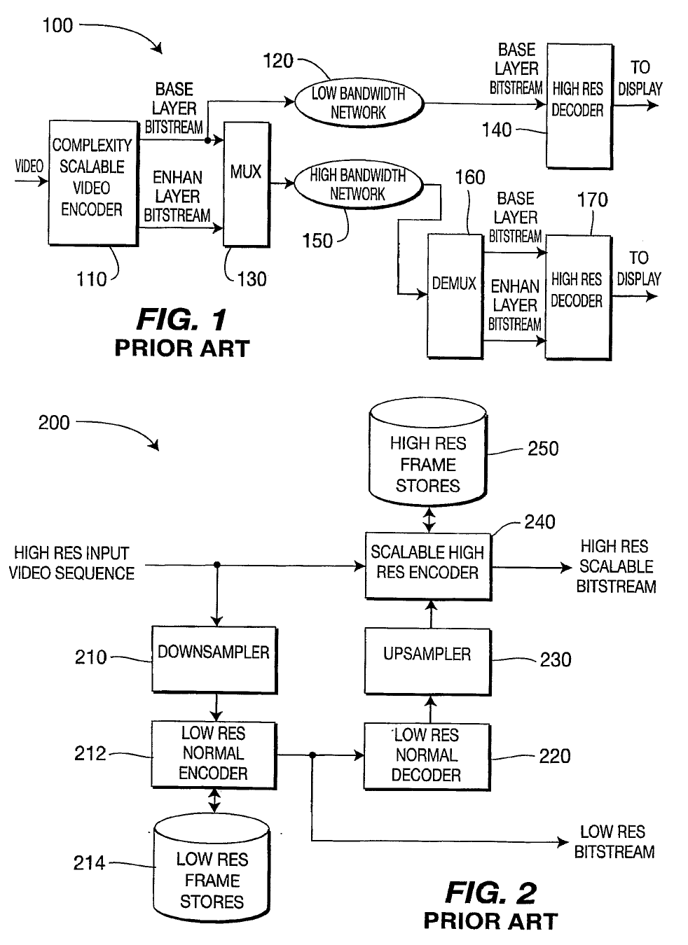

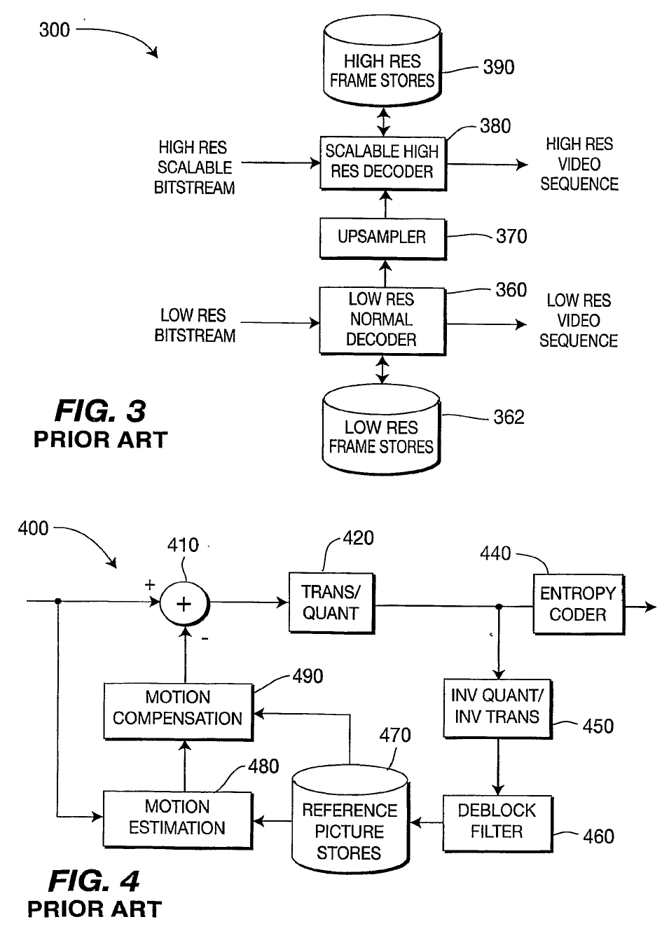

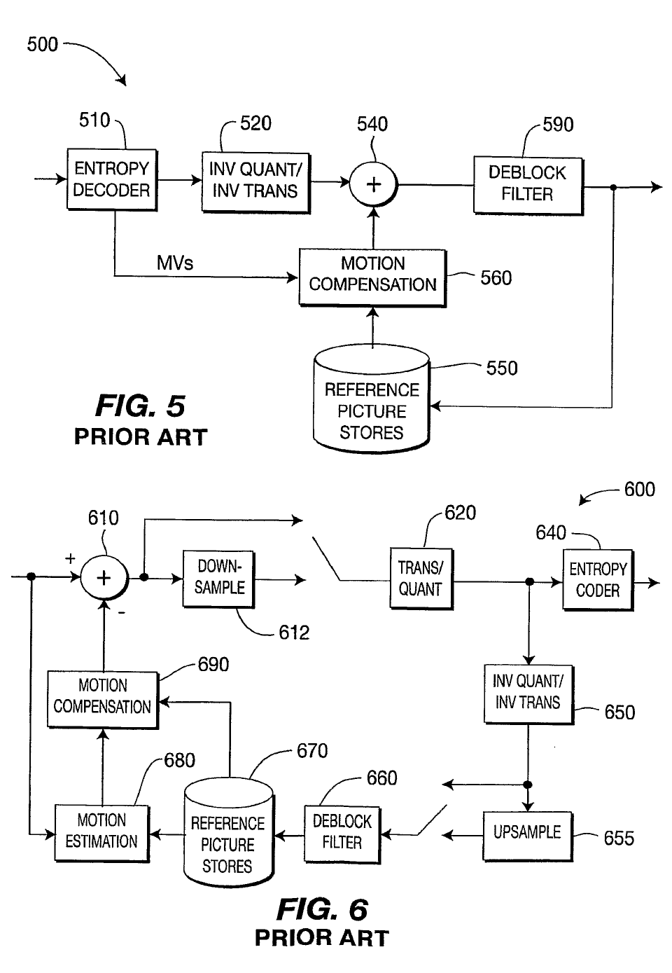

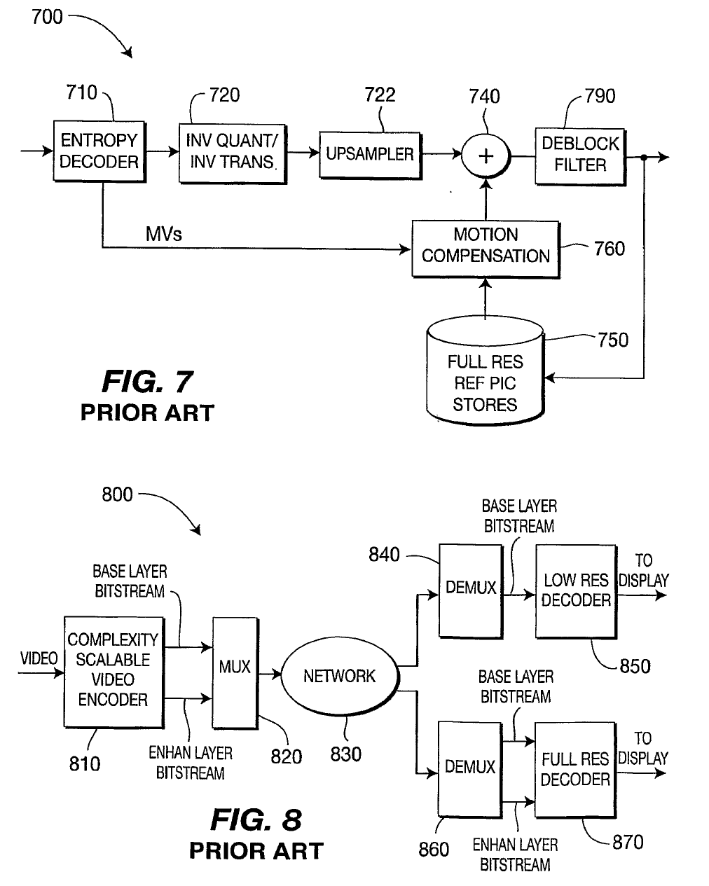

### DETAILED DESCRIPTION

The present principles are directed to a method and apparatus for constrained prediction for Reduced Resolution Update mode and complexity scalability in video encoders and decoders

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles means that a particular feature, structure, characteristic, and so forth described in connection with the embodiment is included in at least one embodiment of the present principles. Thus, the appearances of the phrase “in one embodiment” or “in an embodiment” appearing in various places throughout the specification are not necessarily all referring to the same embodiment.

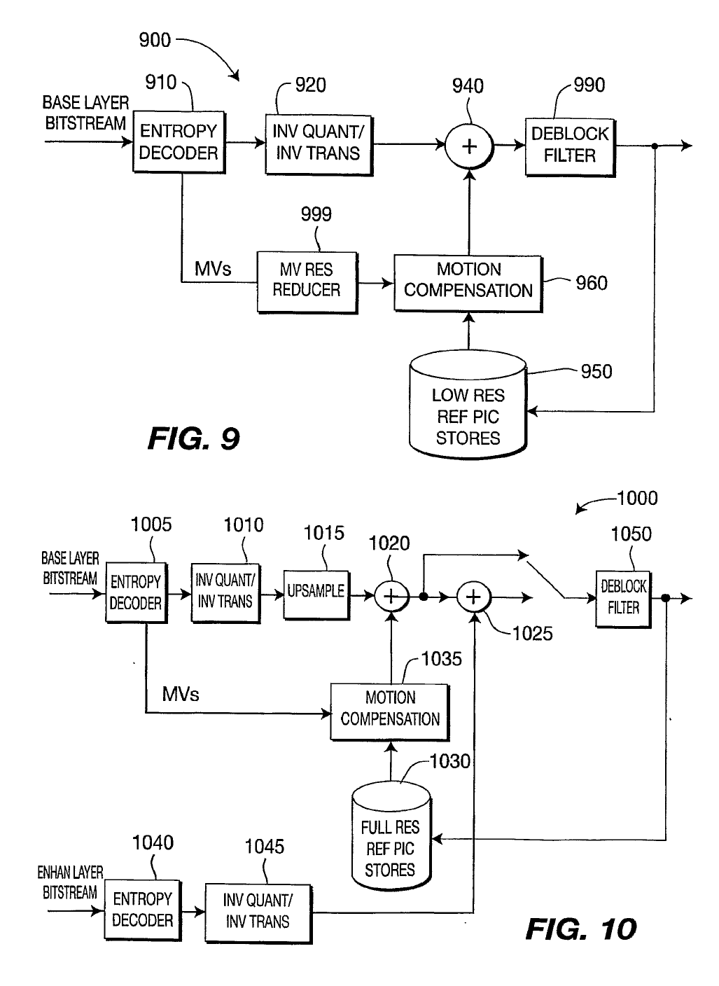

Turning to FIG. 9, an exemplary low resolution complexity scalable video decoder to which the present principles may be applied is indicated generally by the reference numeral 900. The video decoder 900 includes an entropy decoder 910 for receiving a video sequence. A first output of the entropy decoder 910 is connected in signal communication with an input of an inverse quantizer/transformer 920. An output of the inverse quantizer/transformer 920 is connected in signal communication with a first non-inverting input of a combiner 940.

The output of the combiner 940 is connected in signal communication with an input of a deblock filter 990. An output of a deblock filter 990 is connected in signal communication with an input of a reference picture stores 950. The output of the deblock filter 990 is also available as an output of the video decoder 900. An output of the reference picture stores 950 is connected in signal communication with a first input of a motion compensator 960. An output of the motion compensator 960 is connected in signal communication with a second non-inverting input of the combiner 940. A second output of the entropy decoder 910 is connected in signal communication with an input of a motion vector (MV) resolution reducer 999. An output of the MV resolution reducer 999 is connected in signal communication with a second input of the motion compensator 960.

In the decoder 900, the base layer bitstream is entropy decoded. The motion vectors are rounded to reduce them in accuracy to correspond to the low resolution. The complexity of this low resolution scalable decoder is very similar to that of a non-scalable decoder, as scaling of motion vectors is of very low complexity. If factors of 2 are used in the resolution ratios in each dimension between the low and full resolution, then the rounding can be implemented with just a right shift or an add and a right shift, depending whether rounding up or rounding down is selected in the system.

Turning to FIG. 10, an exemplary high resolution complexity scalable video decoder 1000 to which the present principles may be applied is indicated generally by the reference numeral 1000. The video decoder 1000 includes a first entropy decoder 1005 for receiving a base layer bitstream. An output of the first entropy decoder 1005 is connected in signal communication with an input of a first inverse quantizer/transformer 1010. An output of the first inverse quantizer/transformer 1010 is connected in signal communication with an input of an upsampler 1015. An output of the upsampler 1015 is connected in signal communication with a first input of a first combiner 1020.

An output of the first combiner 1020 is connected in signal communication with a first input of a second combiner 1025. An output of a full resolution reference picture stores 1030 is connected in signal communication with a first input of a motion compensator 1035. A second output of the entropy decoder (for outputting motion vectors (MVs)) 1005 is connected in signal communication with a second input of the motion compensator 1035. An output of the motion compensator 1035 is connected in signal communication with a second input of the first combiner 1020.

An input of a second entropy decoder 1040 is for receiving an enhanced layer bitstream. An output of the second entropy decoder 1040 is connected in signal communication with an input of a second inverse quantizer/transformer 1045. An output of the second inverse quantizer/transformer 1045 is connected in signal communication with a second input of the second combiner 1025.

An input to a deblock filter 1050 is connected in signal communication with an output of the first combiner 1020 or with an output of the second combiner 1025. The output of the deblock filter 1050 is connected in signal communication with an input of the full resolution reference picture store 1030. The output of the deblock filter 1050 is available as an output of the video decoder 1000.

The portion of the decoder 1000 that operates on the base layer bitstream is similar to an RRU decoder. After entropy decoding and inverse quantization and inverse transform, the residual is upsampled. Motion compensation is applied to the full resolution reference pictures to form a full resolution prediction, and the upsampled residual is added to the prediction. If a full resolution error signal is present in the enhancement layer bitstream, it is entropy decoded and inversed quantized and transformed, and then added to the RRU reconstructed signal. The deblocking filter is then applied.

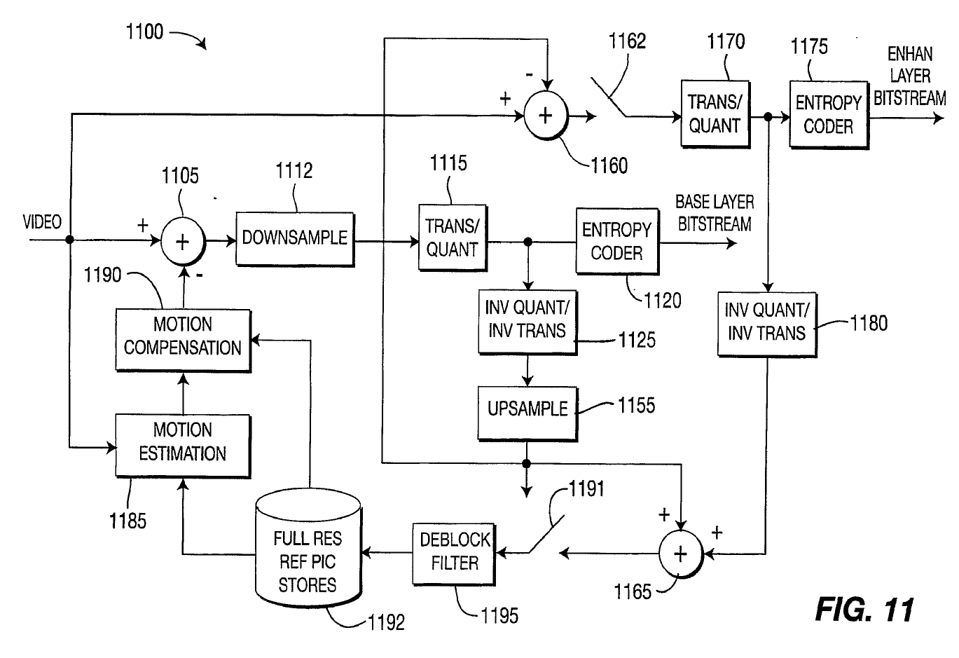

Turning to FIG. 11, an exemplary complexity scalable video encoder to which the present principles may be applied is indicated generally by the reference numeral 1100. An input to the video encoder 1100 is connected in signal communication with a non-inverting input of a first combiner 1105. The output of the first combiner 1105 is connected in signal communication with an input of a downsampler 1112. An output of the downsampler 1112 is connected in signal communication with an input of a first transformer/quantizer 1115. An output of the first transformer/quantizer 1115 is connected in signal communication with an input of a first entropy coder 1120. An output of the first entropy coder 1120 is available as an output of the encoder 1100 for a base layer bitstream.

The output of the first transformer/quantizer 1115 is further connected in signal communication with an input of a first inverse transformer/quantizer 1125. An output of the first inverse transformer/quantizer 1125 is connected in signal communication with an input of an upsampler 1155. An output of the upsampler 1155 is connected in signal communication with an inverting input of a second combiner 1160, a first non-inverting input of a third combiner 1165, and an input of a switch 1191.

The input to the video encoder 1100 is further connected in signal communication with a non-inverting input of a second combiner 1160. An output of the second combiner 1160 is connected in signal communication with an input of a switch 1162. An output of the switch 1162 is connected in signal communication with an input to a second transformer/quantizer 1170. An output of the second transformer/quantizer 1170 is connected in signal communication with an input of a second entropy coder 1175. An output of the second entropy coder 1175 is available as an output of the encoder 1100 for an enhanced layer bitstream. The output of the second transformer/quantizer 1170 is further connected in signal communication with an input of a second inverse transformer/quantizer 1180. An output of the second inverse transformer/quantizer 1180 is connected in signal communication with a second non-inverting input of the third combiner 1165.

The input to the video encoder 1100 is yet further connected in signal communication with a first input of a motion estimator 1185. An output of the motion estimator 1185 is connected in signal communication with a first input of a motion compensator 1190. An output of the motion compensator 1190 is connected in signal communication with an inverting input of the first combiner 1105. A first output of a full resolution reference picture stores 1192 is connected in signal communication with a second input of the motion estimator 1185. A second output of the full resolution reference picture stores 1192 is connected in signal communication with a second input of the motion compensator 1190. An input of the full resolution reference picture stores 1192 is connected in signal communication with an output of a deblock filter 1195. An input of the deblock filter 1195 is connected in signal communication with an output of the switch 1191. Another input of the switch 1191 is connected in signal communication with an output of the third combiner 1165.

The encoder 1100 attempts to optimize the full resolution video quality rather than the low resolution video quality. Motion estimation is performed on the full resolution video picture. After subtraction the motion compensated prediction from the input picture, the prediction residual is downsampled. Unlike in the RRU codec, the downsampling is applied to all pictures, so that the low resolution decoder can always have a picture to decode. The downsampled residual is transformed and quantized, and entropy coded. This forms the base layer bitstream. The inverse quantizer and inverse transform is applied, and then the coded residual is upsampled back to the full resolution. The encoder 1100 can choose whether or not to send an enhancement layer full resolution error signal for the picture or slice. In general, an enhancement layer full resolution error signal is coded for all I slices, and can be optionally sent for P and B slices based on the magnitude of the error signal when the full resolution input picture subtracts the decoded upsampled. If an enhancement layer full resolution error signal is to be coded, the coded base layer upsampled coded picture is subtracted from the input full resolution picture. The difference is then quantized, transformed and entropy coded to form the enhancement layer bitstream. The enhancement layer bitstream can be seen as containing only intra-coded slices.

In accordance with the present principles, we further improve subjective quality for complexity scalable decoders by introducing certain constraints that affect the intra-prediction process for video encoding and decoding.

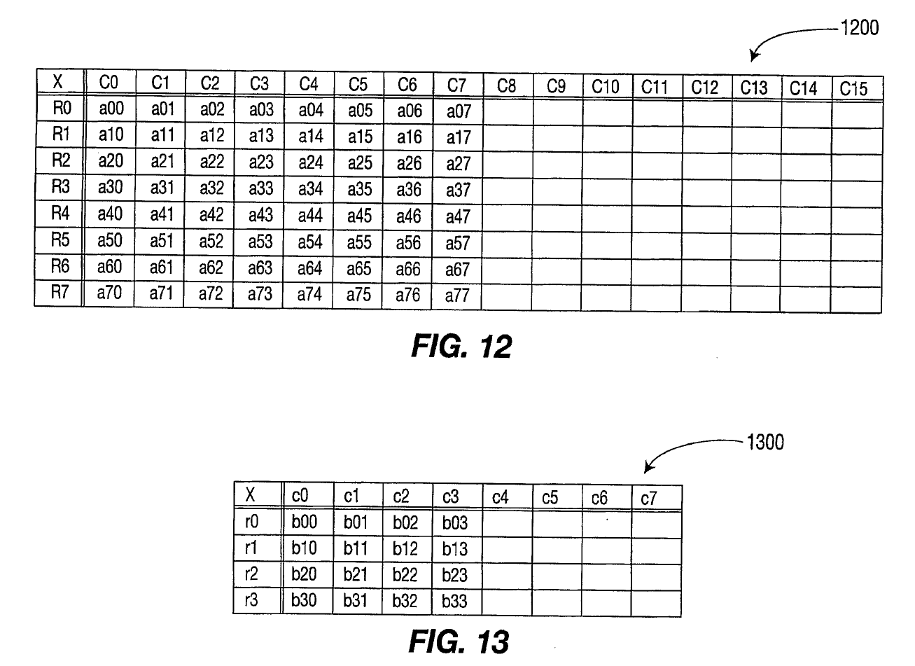

We have observed that the intra prediction methods originally proposed for the RRU mode, although efficient in terms of encoding performance, could lead to severe artifacts if RRU slices are considered within a complexity scalability system. These artifacts are mainly due to the way that adjacent pixels are considered within the intra prediction process, especially in the case of directional prediction modes, within the low and high complexity decoders. Turning to FIG. 12, predictor pixels for a high complexity decoder are indicated generally by the reference numeral 1200. The predictor pixels 1200 include pixels C0-C15, X, and R0-R8. Turning to FIG. 13, predictor pixels for a low complexity decoder are indicated generally by the reference numeral 1300. The predictor pixels 1300 includes pixels c0-c7, x, and r0-r3. We observe though that for the original RRU implementation, the dispersion between prediction pixels for intra prediction is much higher for the low complexity decoder compared to the original resolution video. This basically has an immediate impact in all intra directional modes considering that no consideration of this dispersion was made in the high complexity decoder of the conventional method. For example, for the first sample (a00) of the vertical left prediction, samples C0 and C1 were considered for the high complexity one, while for the low complexity sample b00 was predicted from sample c0 and c1. c1 nevertheless has a much higher relationship with samples C2 and C3. If, for example, c1 corresponds to an edge, this could considerably alter the characteristics of this prediction and, therefore, potentially create artifacts within the decoded low complexity sequence. The same problem happens when averaging any other prediction samples due to a different directional prediction mode.

Although the simplest solution to avoid this problem is to forbid all directional modes for intra coding, this may not be the best solution in terms of efficiency. Instead, we propose modifying the intra prediction of RRU slices for the higher complexity decoder to consider this relationship between the high and low complexity decoded sequences.

More specifically, we propose performing prediction for the high complexity decoder by first downsampling the original full resolution samples (FIG. 12), and then creating a low resolution prediction based on these new samples (FIG. 13). Subsequently, this low resolution prediction is upsampled to full resolution (e.g., using zero order hold) and used for prediction. Downsampling can be performed using various methods. For example, we may keep only odd prediction samples (x=X, c1=C1, c3=C3, c5=C5, c7=C7, c9=C9, c11=C11, c13=C13, c15=C15, r1=R1, r3=R3, r5=R5 and r7=R7), even samples, or by performing simple averaging (x=X, c1=(C0+C1)>>1, c3=(C2+C3)>>1, c5=(C4+C5)>>1, c7=(C6+C7)>>1, c9=(C8+C9)>>1, c11=(C10+C11)>>1, c13=(C12+C13)>>1, c15=(C14+C15)>>1, r1=(R0+R1)>>1, r3=(R2+R3)>>1, r5=(R4+R5)>>1 and r7=(R6+R7)>>1).

To improve performance, in an alternate embodiment, odd samples are considered for odd positions, and even samples are considered for even positions.

Although this method could, in certain cases, improve subjective quality for the low complexity decoder, it can also hurt performance for the high complexity decoder. Therefore, we propose signaling this method using high level syntax, at the slice header or macroblock level, by introducing a new parameter named “rru_complexity_constrained_flag”. If this parameter is enabled, then prediction for intra blocks within the high complexity decoder is performed as above. In contrast, if this parameter is disabled, then prediction is performed as in the conventional method. It is to be appreciated that the consideration of this parameter could lead to a performance tradeoff between the low and high complexity decoders.

The quality of the low complexity decoder can be improved by performing certain decisions during encoding, especially with regard to intra modes, based on the quality of low complexity decoded sequence. More specifically, usually mode decision is performed by considering a distortion criterion compared to the original source image. A very common method is the use of Lagrangian optimization, i.e., the computation of J=D+λ*R, where D is the distortion, R is the bits required to encode the current data, and λ the Lagrangian multiplier. A simple method to improve quality for the low complexity decoder is to consider distortion only for the low complexity decoder, for example, by considering as a “source” a downsampled version of the original video sequence. An improved method that provides improved quality for both low and high complexity decoders is to consider the impact in quality for both cases. Therefore, we propose computing distortion D according to D=a*D_{H}+b*D_{L}, where D_{H} is the distortion of the high complexity decoder, D_{L} is the distortion, based on the downsampled source, of the low complexity decoder, and a and b are weighting parameters that enable a quality tradeoff between the high and low complexity decoders.

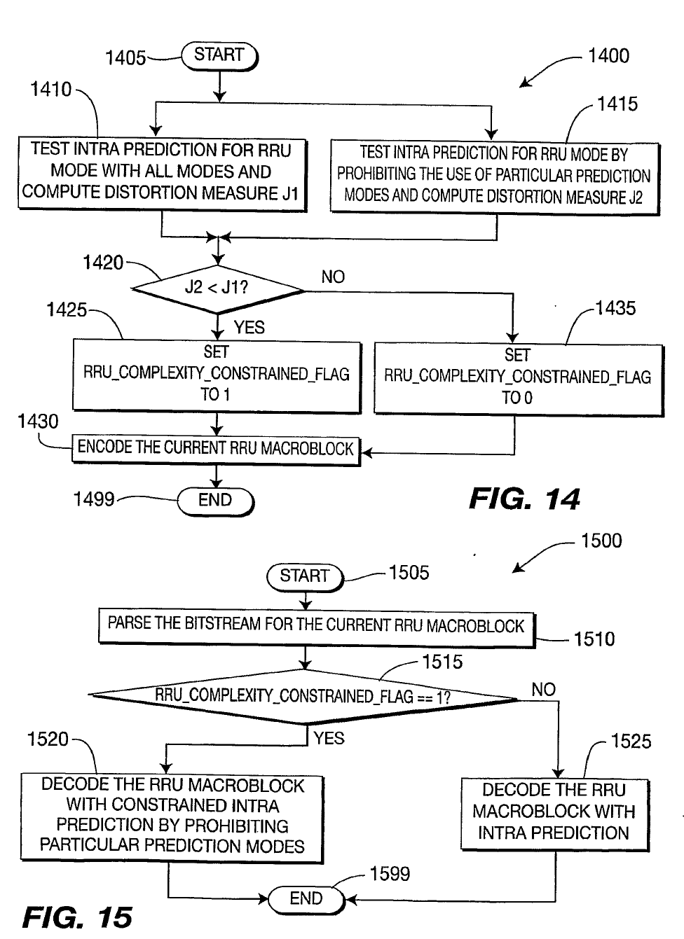

Turning to FIG. 14, an exemplary method for encoding a macroblock using constrained intra prediction for a Reduced Resolution Update (RRU) mode is indicated generally by the reference numeral 1400. The constrained intra prediction prohibits particular prediction modes for the RRU mode so as to reduce artifacts for both low and high resolutions in the RRU mode when the picture is eventually decoded.

The method 1400 includes a start block 1405 that passes control to a function block 1410 and a function block 1415.

The function block 1410 tests intra prediction for a current macroblock for RRU mode with all modes, computes a distortion measure J1, and passes control to a decision block 1420.

The function block 1415 tests intra prediction for a current macroblock for RRU mode by prohibiting the use of particular prediction modes, computes a distortion measure J2, and passes control to the decision block 1420.

The decision block 1420 determines whether the distortion measure J1 is less than the distortion measure J2. If so, then control is passed to a function block 1425. Otherwise, control is passed to a function block 1435.

The function block 1425 sets rru_complexity_constrained_flag equal to one, and passes control to a function block 1430. The function block 1430 encodes the current RRU macroblock, and passes control to an end block 1499.

The function block 1435 sets rru_complexity_constrained_flag equal to zero, and passes control to the function block 1430.

Turning to FIG. 15, an exemplary method for decoding a macroblock using constrained intra prediction for a Reduced Resolution Update (RRU) mode is indicated generally by the reference numeral 1500. The constrained intra prediction prohibits particular prediction modes for the RRU mode so as to reduce artifacts for both low and high resolutions in the RRU mode when the picture is eventually decoded.

The method 1500 includes a start block 1505 that passes control to a function block 1510. The function block 1510 parses the bitstream for the current RRU macroblock, and passes control to a decision block 1515. The decision block 1515 determines whether or not rru_complexity_constrained_flag is equal to one. If so, then control is passed to a function block 1520. Otherwise, control is passed to a function block 1525.

The function block 1520 decodes the RRU macroblock with constrained intra prediction by prohibiting particular prediction modes, and passes control to an end block 1599.

The function block 1525 decodes the RRU macroblock with intra prediction, and passes control to the end block 1599.

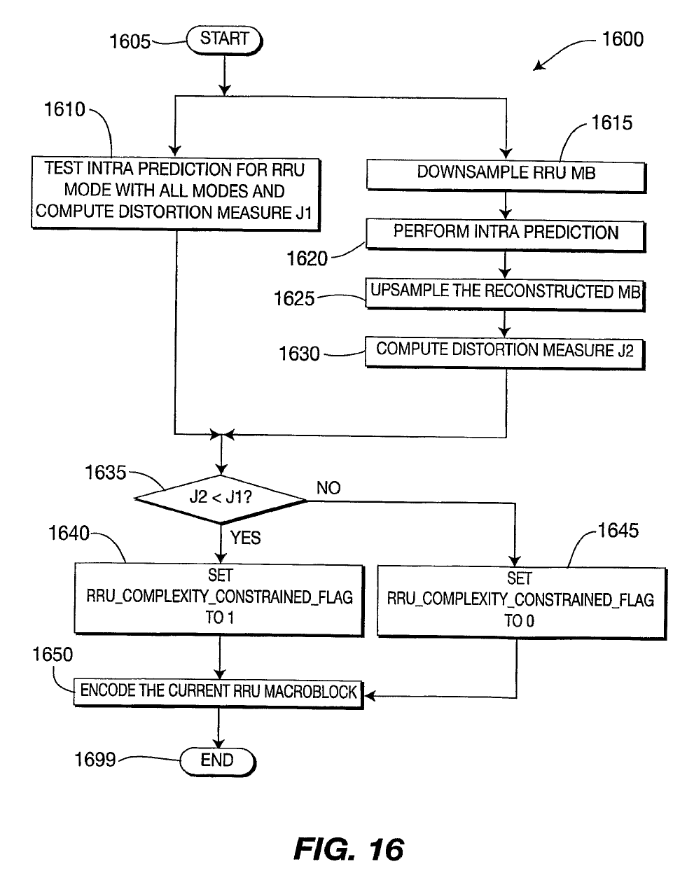

Turning to FIG. 16, an exemplary method for encoding a macroblock of a high resolution picture in a video sequence at a high resolution using modified intra prediction for a Reduced Resolution Update (RRU) mode is indicated generally by the reference numeral 1600.

The method 1600 includes a start block 1605 that passes control to a function block 1610 and a function block 1615. The function block 1610 tests intra prediction for RRU mode with all modes, computes a distortion measure J1, and passes control to a decision block 1635.

The function block 1615 downsamples a RRU macroblock in the picture, and passes control to a function block 1620. The function block 1620 performs intra prediction, and passes control to a function block 1625. The function block 1625 upsamples the reconstructed macroblock, and passes control to a function block 1630. The function block 1630 computes a distortion measure J2, and passes control to the decision block 1635.

The decision block 1635 determines whether or not the distortion measure J2 is less than the distortion measure J1. If so, then control is passed to a function block 1640. Otherwise, control is passed to a function block 1645.

The function block 1640 sets rru_complexity_constrained_flag equal to one, and passes control to a function block 1650. The function block 1650 encodes the current RRU macroblock, and passes control to an end block 1699.

The function block 1645 sets rru_complexity_constrained_flag equal to zero, and passes control to the function block 1650.

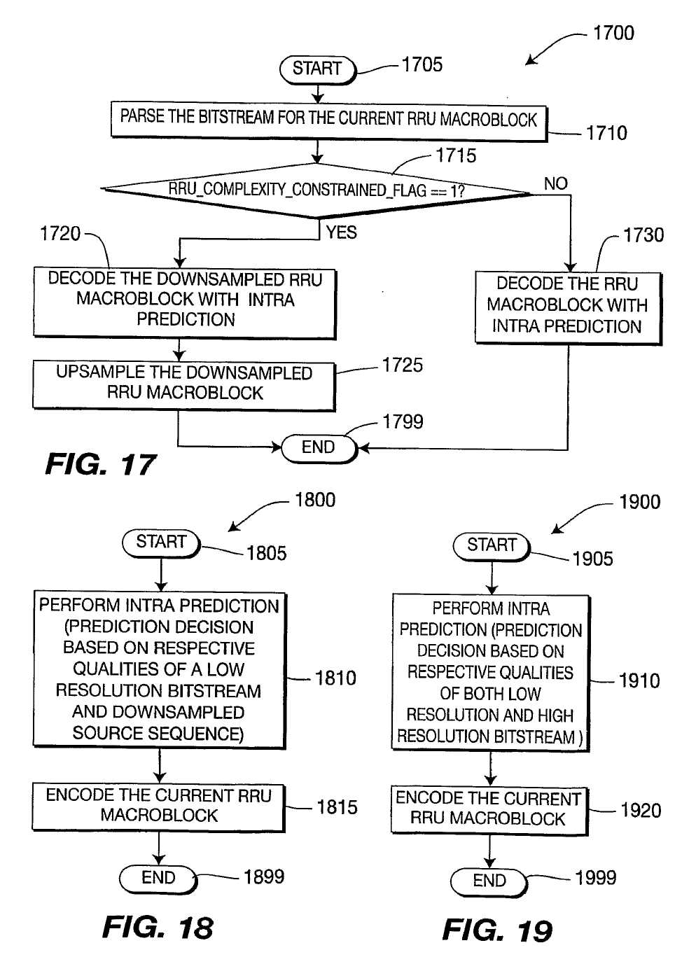

Turning to FIG. 17, an exemplary method for decoding a macroblock of a high resolution picture in a video bitstream at a high resolution using modified intra prediction for a Reduced Resolution Update (RRU) mode is indicated generally by the reference numeral 1700.

The method 1700 includes a start block 1705 that passes control to a function block 1710. The function block 1710 parses the bitstream for the current RRU macroblock, and passes control to the decision block 1715.

The decision block 1715 determines whether or not rru_complexity_constrained_flag is equal to one. If so, then control is passed to a function block 1720. Otherwise, control is passed to a function block 1730.

The function block 1720 decodes the downsampled RRU macroblock with intra prediction, and passes control to a function block 1725. The function block 1725 upsamples the downsampled RRU macroblock, and passes control to an end block 1799.

The function block 1730 decodes the RRY macroblock with intra prediction, and passes control to the end block 1799.

Turning to FIG. 18, an exemplary method for encoding a macroblock in a particular picture in a video sequence using certain intra mode decisions for a Reduced Resolution Update (RRU) mode is indicated generally by the reference numeral 1800. Decisions for the modified intra prediction process are based on respective qualities of a low resolution bitstream encoded from the video sequence and to a downsampled source sequence encoded from the video sequence.

The method 1800 includes a start block 1805 that passes control to a function block 1810. The function block 1810 performs intra prediction (with prediction decision based on respective qualities of a low resolution bitstream and downsampled source sequence), and passes control to a function block 1815. The function block 1815 encodes the current RRU macroblock, and passes control to an end block 1899.

Turning to FIG. 19, an exemplary method for encoding a macroblock in a particular picture in a video sequence using certain intra mode decisions for a Reduced Resolution Update (RRU) mode is indicated generally by the reference numeral 1900. Decisions for the modified intra prediction process are based on respective qualities of a low resolution bitstream encoded from the video sequence and a high resolution bitstream encoded from the video sequence.

The method 1900 includes a start block 1905 that passes control to a function block 1910. The function block 1910 performs intra prediction (with prediction decision based on respective qualities of a low resolution bitstream and a high resolution bitstream), and passes control to a function block 1915. The function block 1915 encodes the current RRU macroblock, and passes control to an end block 1999.

A description will now be given of some of the many attendant advantages/features of the present invention, some of which have been mentioned above. For example, one advantage/feature is a scalable complexity video encoder for encoding a video sequence, the scalable complexity video encoder including an encoder for encoding a block in a particular picture in the video sequence by generating an intra mode prediction for the block using a constrained intra prediction process that reduces artifacts for both low and high resolutions in a Reduced Resolution Update mode when the particular picture is eventually decoded. The constrained intra prediction process reduces the artifacts by prohibiting the use of particular prediction modes associated with the introduction of the artifacts in the Reduced Resolution Update mode. Another advantage/feature is the scalable complexity video encoder as described above, wherein the particular prediction modes associated with the introduction of the artifacts and prohibited from use by the constrained intra prediction process comprise directional intra prediction modes. Moreover, another advantage/feature is the scalable complexity video encoder as described above, wherein the encoder signals a use of the constrained intra prediction process for the block using at least one of a block-level syntax, a slice-level syntax, and a high-level syntax.

Further, another advantage/feature is a scalable complexity video encoder for encoding a video sequence, the scalable complexity video encoder including an encoder for encoding a block in a particular high resolution picture in the video sequence at a high resolution by generating a low resolution intra mode prediction for the block in a Reduced Resolution Update mode. Also, another advantage/feature is the scalable complexity video encoder as described above, wherein the encoder downsamples the block at the high resolution to obtain a downsampled block, generates the low resolution intra prediction based on the downsampled block, reconstructs the block at a low resolution using the low resolution intra prediction and a residue between the low resolution intra prediction and the downsampled block, and upsamples the reconstructed block to the high resolution. Additionally, another advantage/feature is the scalable complexity video encoder as described above, wherein the encoder selects at least one original high resolution sample corresponding to the block for the downsampling according to predicted sample position within the block. Moreover, another advantage/feature is the scalable complexity video encoder as described above, wherein the encoder performs the downsampling by at least one of averaging and filtering the at least one original high resolution sample. Also, another advantage/feature is the scalable complexity video encoder as described above, wherein the encoder uses a modified intra prediction process to generate the low resolution intra mode prediction for the block, and signals a use of the modified intra prediction process using at least one of a block-level syntax, a slice-level syntax, and a high-level syntax.

Additionally, another advantage/feature is a scalable complexity video encoder for encoding a video sequence, the scalable complexity video encoder including an encoder for encoding a block in a particular picture in the video sequence by generating an intra mode prediction for the block using a modified intra prediction process that reduces artifacts in a Reduced Resolution Update mode when the particular picture is eventually decoded. The encoder renders encoding decisions for the modified intra prediction process based on respective qualities of a low resolution bitstream encoded from the video sequence and a downsampled source sequence encoded from the video sequence. Moreover, another advantage/feature is the scalable complexity video encoder as described above, wherein the encoder evaluates the respective qualities using Lagrangian optimization techniques. Further, another advantage/feature is the scalable complexity video encoder as described above, wherein the encoder determines weighted distortion values for the low resolution bitstream and the downsampled source sequence for use in rendering the encoding decisions for the modified intra prediction process.

Also, another advantage/feature is a scalable complexity video encoder for encoding a video sequence, the scalable complexity video encoder including an encoder for encoding a block in a particular picture in the video sequence by generating an intra mode prediction for the block using a modified intra prediction process that reduces artifacts in a Reduced Resolution Update mode when the particular picture is eventually decoded. The encoder renders encoding decisions for the modified intra prediction process based on respective qualities of both high and low resolution bitstreams encoded from the video sequence. Additionally, another advantage/feature is the scalable complexity video encoder as described above, wherein the encoder evaluates the respective qualities using Lagrangian optimization techniques. Moreover, another advantage/feature is the scalable complexity video encoder as described above, wherein the encoder determines weighted distortion values for the high resolution bitstream and the low resolution bitstream for use in rendering the encoding decisions for the modified intra prediction process.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus for scalably encoding a video sequence, comprising:
an encoder for encoding a block in a particular picture in the video sequence by generating an intra mode prediction for the block using a constrained intra prediction process that reduces artifacts for both low and high resolutions in a reduced resolution update mode when the particular picture is eventually decoded,
wherein the constrained intra prediction process reduces the artifacts by prohibiting the use of particular prediction modes associated with the introduction of the artifacts in the reduced resolution update mode.

2. The apparatus of claim 1, wherein the particular prediction modes associated with the introduction of the artifacts and prohibited from use by the constrained intra prediction process comprise directional intra prediction modes.

3. The apparatus of claim 1, wherein said encoder signals a use of the constrained intra prediction process for the block using at least one of a block-level syntax, a slice-level syntax, and a high-level syntax.

4. A method for scalable complexity video encoding of a video sequence, comprising:
encoding a block in a particular picture in the video sequence by generating an intra mode prediction for the block using a constrained intra prediction process that reduces artifacts for both low and high resolutions in a reduced resolution update mode when the particular picture is eventually decoded,
wherein the constrained intra prediction process reduces the artifacts by prohibiting the use of particular prediction modes associated with the introduction of the artifacts in the reduced resolution update mode.

5. The method of claim 4, wherein the particular prediction modes associated with the introduction of the artifacts and prohibited from use by the constrained intra prediction process comprise directional intra prediction modes.

6. The method of claim 4, further comprising signaling a use of the constrained intra prediction process for the block using at least one of a block-level syntax, a slice-level syntax, and a high-level syntax.

7. An apparatus for scalably decoding a video bitstream, comprising:
a decoder for decoding a block in a particular picture in the video bitstream using an intra mode prediction for the block generated based upon a constrained intra prediction process that reduces artifacts for both low and high resolutions in a reduced resolution update mode when the particular picture is eventually decoded,
wherein the constrained intra prediction process reduces the artifacts by prohibiting the use of particular prediction modes associated with the introduction of the artifacts in the reduced resolution update mode.

8. The apparatus of claim 7, wherein the particular prediction modes associated with the introduction of the artifacts and prohibited from use by the constrained intra prediction process comprise directional intra prediction modes.

9. The apparatus of claim 7, wherein said decoder determines a use of the constrained intra prediction process for the block based upon at least one of a block-level syntax, a slice-level syntax, and a high-level syntax.

10. A method for scalable complexity video decoding of a video bitstream, comprising:
decoding a block in a particular picture in the video bitstream using an intra mode prediction for the block generated based upon a constrained intra prediction process that reduces artifacts for both low and high resolutions in a reduced resolution update mode when the particular picture is eventually decoded,
wherein the constrained intra prediction process reduces the artifacts by prohibiting the use of particular prediction modes associated with the introduction of the artifacts in the reduced resolution update mode.

11. The method of claim 10, wherein the particular prediction modes associated with the introduction of the artifacts and prohibited from use by the constrained intra prediction process comprise directional intra prediction modes.

12. The method of claim 10, wherein said decoding step determines a use of the constrained intra prediction process for the block based upon at least one of a block-level syntax, a slice-level syntax, and a high-level syntax.

13. A video signal structure for video encoding, comprising:
a block in a particular picture in the video sequence encoded by generating an intra mode prediction for the block using a constrained intra prediction process that reduces artifacts for both low and high resolutions in a reduced resolution update mode when the particular picture is eventually decoded,
wherein the constrained intra prediction process reduces the artifacts by prohibiting the use of particular prediction modes associated with the introduction of the artifacts in the reduced resolution update mode.

14. A storage media having video signal data encoded thereupon, comprising:
a block in a particular picture in the video sequence encoded by generating an intra mode prediction for the block using a constrained intra prediction process that reduces artifacts for both low and high resolutions in a reduced resolution update mode when the particular picture is eventually decoded,
wherein the constrained intra prediction process reduces the artifacts by prohibiting the use of particular prediction modes associated with the introduction of the artifacts in the reduced resolution update mode.

15. An apparatus for scalably encoding a video sequence, comprising:
an encoder for encoding a block in a particular high resolution picture in the video sequence at a high resolution by generating a low resolution intra mode prediction for the block in a reduced resolution update mode.

16. The apparatus of claim 15, wherein said encoder downsamples the block at the high resolution to obtain a downsampled block, generates the low resolution intra prediction based on the downsampled block, reconstructs the block at a low resolution using the low resolution intra prediction and a residue between the low resolution intra prediction and the downsampled block, and upsamples the reconstructed block to the high resolution.

17. The apparatus of claim 16, wherein said encoder selects at least one original high resolution sample corresponding to the block for the downsampling according to predicted sample position within the block.

18. The apparatus of claim 17, wherein said encoder performs the downsampling by at least one of averaging and filtering the at least one original high resolution sample.

19. The apparatus of claim 15, wherein said encoder uses a modified intra prediction process to generate the low resolution intra mode prediction for the block, and signals a use of the modified intra prediction process using at least one of a block-level syntax, a slice-level syntax, and a high-level syntax.

20. A method for scalable complexity video encoding of a video sequence, comprising:
encoding a block in a particular high resolution picture in the video sequence at a high resolution by generating a low resolution intra mode prediction for the block in a reduced resolution update mode.

21. A method of claim 20, wherein said encoding step downsamples the block at the high resolution to obtain a downsampled block, generates the low resolution intra prediction based on the downsampled block, reconstructs the block at a low resolution using the low resolution intra prediction and a residue between the low resolution intra prediction and the downsampled block, and upsamples the reconstructed block to the high resolution.

22. The method of claim 21, wherein said encoding step selects at least one original high resolution sample corresponding to the block for the downsampling according to predicted sample position within the block.

23. The method of claim 22, wherein said encoding step performs the downsampling by at least one of averaging and filtering the at least one original high resolution sample.

24. The method of claim 21, wherein said encoding step uses a modified intra prediction process to generate the low resolution intra mode prediction for the block, and signals a use of the modified intra prediction process using at least one of a block-level syntax, a slice-level syntax, and a high-level syntax.

25. An apparatus for scalably decoding a video bitstream, comprising:
a decoder for decoding a reduced resolution update block in a particular picture in the video bitstream at a high resolution by performing a modified intra prediction process to reconstruct the reduced resolution update block at a low resolution and upsampling the reconstructed reduced resolution update block to the high resolution.

26. The apparatus of claim 27, wherein said decoder determines a use of the modified intra prediction process for the reduced resolution update block based upon at least one of a block-level syntax, a slice-level syntax, and a high-level syntax.

27. A method for scalable complexity video decoding of a video bitstream, comprising:
decoding a reduced resolution update block in a particular picture in the video bitstream at a high resolution by performing a modified intra prediction process to reconstruct the reduced resolution update block at a low resolution and upsampling the reconstructed reduced resolution update block to the high resolution.

28. The method of claim 27, wherein said decoding step determines a use of the modified intra prediction process for the block based upon at least one of a block-level syntax, a slice-level syntax, and a high-level syntax.

29. A video signal structure for video encoding, comprising:
a block in a particular high resolution picture in the video sequence encoded at a high resolution by generating a low resolution intra mode prediction for the block in a reduced resolution update mode.

30. A storage media having video signal data encoded thereupon, comprising:
a block in a particular high resolution picture in the video sequence encoded at a high resolution by generating a low resolution intra mode prediction for the block in a reduced resolution update mode.

31. An apparatus for scalably encoding a video sequence, comprising:
an encoder for encoding a block in a particular picture in the video sequence by generating an intra mode prediction for the block using a modified intra prediction process that reduces artifacts in a reduced resolution update mode when the particular picture is eventually decoded,
wherein said encoder renders encoding decisions for the modified intra prediction process based on respective qualities of a low resolution bitstream encoded from the video sequence and a downsampled source sequence encoded from the video sequence.

32. The apparatus of claim 31, wherein said encoder evaluates the respective qualities using Lagrangian optimization techniques.

33. The apparatus of claim 31, wherein said encoder determines weighted distortion values for the low resolution bitstream and the downsampled source sequence for use in rendering the encoding decisions for the modified intra prediction process.

34. A method for scalable complexity video encoding of a video sequence, comprising:
encoding a block in a particular picture in the video sequence by generating an intra mode prediction for the block using a modified intra prediction process that reduces artifacts in a reduced resolution update mode when the particular picture is eventually decoded,
wherein said encoding step renders encoding decisions for the modified intra prediction process based on respective qualities of a low resolution bitstream encoded from the video sequence and a downsampled source sequence encoded from the video sequence.

35. The method of claim 34, wherein said encoding step evaluates the respective qualities using Lagrangian optimization techniques.

36. The method of claim 34, wherein said encoding step determines weighted distortion values for the low resolution bitstream and the downsampled source sequence for use in rendering the encoding decisions for the modified intra prediction process.

37. An apparatus for scalably encoding a video sequence, comprising:
an encoder for encoding a block in a particular picture in the video sequence by generating an intra mode prediction for the block using a modified intra prediction process that reduces artifacts in a reduced resolution update mode when the particular picture is eventually decoded,
wherein said encoder renders encoding decisions for the modified intra prediction process based on respective qualities of both high and low resolution bitstreams encoded from the video sequence.

38. The apparatus of claim 37, wherein said encoder evaluates the respective qualities using Lagrangian optimization techniques.

39. The apparatus of claim 37, wherein said encoder determines weighted distortion values for the high resolution bitstream and the low resolution bitstream for use in rendering the encoding decisions for the modified intra prediction process.

40. A method for scalable complexity video encoding of a video sequence, comprising:
encoding a block in a particular picture in the video sequence by generating an intra mode prediction for the block using a modified intra prediction process that reduces artifacts in a reduced resolution update mode when the particular picture is eventually decoded,
wherein said encoding step renders encoding decisions for the modified intra prediction process based on respective qualities of both high and low resolution bitstreams encoded from the video sequence.

41. The method of claim 40, wherein said encoding step evaluates the respective qualities using Lagrangian optimization techniques.

42. The method of claim 40, wherein said encoding step determines weighted distortion values for the high resolution bitstream and the low resolution bitstream for use in rendering the encoding decisions for the modified intra prediction process.
